(19) United States
(12) Patent Application Publication
(10) Pub. No.: US 2010/0221966 A1
(43) Pub. Date: Sep. 2, 2010

(54) WATERPROOF CLOTH CONTAINING PLANT-DERIVED COMPONENT

(76) Inventors: Kiyoshi Kawakami, Kyoto (JP); Toru Osumi, Kyoto (JP); Masanori Uemoto, Kyoto (JP); Naotaka Nishimura, Kyoto (JP); Takayuki Kouketsu, Kyoto (JP)

Correspondence Address: JORDAN AND HAMBURG LLP, 122 EAST 42ND STREET, SUITE 4000, NEW YORK, NY, 10168, US

(21) Appl. No.: 12/681,059

(22) PCT Filed: Oct. 3, 2008
(86) PCT No.: PCT/JP2008/068082

§ 371 Date: Mar. 31, 2010

(30) Foreign Application Priority Data
Oct. 5, 2007 (JP) 2007-261654

(51) Int. Cl. D06M 15/564; B32B 27/12; B32B 27/40

(52) U.S. Cl. 442/76; 442/89

(57) ABSTRACT

A waterproof cloth is provided that solves the problem in durability of the conventional biodegradable plant-derived component resin, such as a polylactic acid resin, and exhibits excellent comfort. The waterproof cloth contains a cloth having formed on one surface thereof by a coating method or a joining method a waterproof layer containing a polyurethane resin film containing from 10 to 65% by weight of a plant-derived component.

### BACKGROUND OF THE INVENTION

The present invention relates to a waterproof cloth, and more specifically it relates to a waterproof cloth exhibiting comfort capable of being favorably used for sporting clothing, particularly outdoor sporting clothing, rainwear, and the like, and relates to a waterproof cloth containing a plant-derived component contributing to carbon neutral for reducing the environmental load in the countermeasures against global warming in recent years.

With respect to a waterproof cloth containing a plant-derived component, for example, Patent Document 1 discloses a porous waterproof cloth having good biodegradability using a polylactic acid resin as a plant-derived component.

However, a conventional waterproof cloth having good biodegradability is apprehended to suffer a problem in durability upon practical use when the cloth is applied to sporting clothing, rainwear and the like. Specifically, currently available ordinary polylactic acid resin fibers are difficult to maintain the strength even in a hydrolyzability evaluation test (70° C.×95% RH) for one week, and thus it is the current situation that they are not used in a purpose where durability is required. Accordingly, a porous waterproof cloth having good biodegradability using a polylactic acid resin as a plant-derived component is difficult to be subjected to practical use.

### Patent Document 1: JP-A-2002-20530

### SUMMARY OF THE INVENTION

The invention is to solve the problem in durability against hydrolysis, which cannot be solved only by a plant-derived component, such as a polylactic acid resin, and to provide a waterproof cloth exhibiting comfort.

As a result of earnest investigations made by the inventors, it has been found that the problems are solved by providing a polyurethane resin film containing from 10 to 65% by weight of a plant-derived component on one surface of a cloth by a coating method or a joining method, and thus the invention has been completed.

Accordingly, the waterproof cloth of the invention contains a cloth having formed on one surface thereof by a coating method or a joining method a waterproof layer containing a polyurethane resin film containing from 10 to 65% by weight of a plant-derived component.

The polyurethane resin film containing from 10 to 65% by weight of a plant-derived component may be a finely porous film or a non-porous film having moisture permeability.

The waterproof layer may contain a finely porous film containing a polyurethane resin containing from 10 to 65% by weight of a plant-derived component and a non-porous film having moisture permeability containing a polyurethane resin containing from 10 to 65% by weight of a plant-derived component laminated on each other.

A polyol component constituting the polyurethane resin used is preferably a castor oil diol.

The castor oil diol is particularly preferably a castor oil series polyetherpolyester diol having an average hydroxyl group number of from 1.8 to 2.1 and a hydroxyl group value of from 41 to 85 mgKOH/g.

The waterproof cloth of the invention preferably has a withstand water pressure of 10 kPa or more.

It preferably has a moisture permeability of 104 g/m²·hr or more according to the A-1 method of JIS L1099.

Furthermore, it preferably has durability that provides a maintenance ratio of withstand water pressure of 80% or more after lapsing 3 weeks in a hydrolyzability evaluation test under conditions of a temperature of 70° C. and a humidity of 95% RH.

The waterproof cloth of the invention exhibits comfort capable of being favorably used for outdoor sporting clothing, rainwear, and the like. It also contributes, owing to the use of the plant-derived component, to carbon neutral for reducing the environmental load in the countermeasures against global warming.

By using mainly a castor oil diol as a polyol component of the polyurethane resin, the durability, which is a problem in a biodegradable plant-derived component resin, such as a polylactic acid resin, can be improved, and thus such durability is achieved that is equivalent to or higher than polyester polyurethane containing a petroleum component in a hydrolyzability evaluation test (70° C.×95% RH).

### DETAILED DESCRIPTION OF THE INVENTION

The waterproof cloth of the invention, as described above, has a waterproof layer formed with a polyurethane resin containing a plant-derived component on one surface by a coating method or a joining method. The invention will be described in detail below.

### 1. Cloth

As the cloth used in the waterproof cloth of the invention, one suitable for a purpose may be appropriately used, the material of which is not particularly limited, and examples thereof include synthetic fibers, such as nylon fibers, polyester fibers and polyamide fibers; semi-synthetic fibers, such as acetate fibers; and natural fibers, such as cotton, hemp and wool. These kinds of fibers may be used solely or as a mixture of two or more kinds of them. The texture thereof is also not particularly limited, and a woven fabric, a knitted fabric, a nonwoven fabric and the like may be appropriately used.

### 2. Waterproof Layer

As the polyurethane resin containing from 10 to 65% by weight of a plant-derived component for forming the waterproof layer, one synthesized by using a plant-derived component, such as a divalent plant-derived polyol, as the polyol component is preferably used.

As the divalent plant-derived polyol, a castor oil diol is preferably used since a polyurethane resin excellent in hydrolyzability can be obtained.

Castor oil mainly contains a triglyceride of ricinoleic acid represented by the following formula:

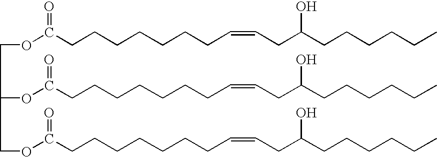

Ricinoleic acid is a compound having the structure represented by the following formula:

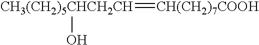

The castor oil diol referred in the invention is a diol derived from castor oil. Particularly, a castor oil series polyetherpolyester diol having an average hydroxyl group number of from 1.8 to 2.1 and a hydroxyl group value of from 41 to 85 mgKOH/g is preferred, and one having an average hydroxyl group number of from 1.95 to 2.05 is particularly preferably used. When the hydroxyl group number exceeds 2.1, a polyurethane resin that is suitable for a coating operation for forming a resin film may be difficultly obtained since a branched or crosslinked structure is formed due to a trivalent polyol. In other words, the urethane resin used in the invention preferably has a linear structure with less branched or crosslinked structure, and preferably provides a viscosity of a solution capable of being coated on a cloth. Increase of a branched structure provides an increased viscosity, which is not suitable for a coating operation. A crosslinked structure causes change in viscosity only with a slight amount thereof, and large viscosity change occurs with a small amount thereof. When the crosslinking amount is further increased, an urethane resin solution may not be obtained.

The ratio of the plant-derived component in the polyurethane resin is preferably as large as possible from the standpoint of reduction of the environmental load, but for enhancing the capability of the polyurethane resin film to provide the waterproof cloth as an object of the invention, the lower limit thereof is 10% by weight, whereas the upper limit thereof is 65% by weight. It is more preferably from 25 to 65% by weight from the standpoint of reduction of the environmental load.

### 3. Characteristics and Production Method of Waterproof Cloth

The waterproof cloth of the invention preferably has a withstand water pressure of 10 kPa or more from the standpoint of practical waterproofing.

Furthermore, the maintenance ratio of durability is preferably 80% or more after lapsing 3 weeks in a hydrolyzability evaluation test (jungle test at 70° C.×95% RH) from the standpoint of practical durability.

In the invention, the polyetherpolyester polyol derived from castor oil is used as the divalent polyol as a raw material of the polyurethane as described above, whereby the maintenance ratio of withstand water pressure of the waterproof cloth can be 80% or more after lapsing 3 weeks in the hydrolyzability evaluation test. Furthermore, a waterproof cloth having significant durability with a maintenance ratio of withstand water pressure of 50% or more after lapsing 15 weeks, which is 5 times the ease where an ordinary polyester polyol is used, is obtained.

The waterproof cloth of the invention preferably has a moisture permeability of 104 g/m²·hr or more according to the A-1 method or 104 g/m²·hr or more according to the B-1 method.

Moisture permeability can be imparted to the polyurethane resin film containing a plant-derived component by making the polyurethane resin into a finely porous film by a wet method. Furthermore, for imparting moisture permeability to a non-porous film, for example, a polyol containing polyethylene glycol is copolymerized in the polymerization of the polyurethane resin containing a plant-derived component, and a resin film is formed by a dry method.

The non-porous film having moisture permeability maybe laminated on the finely porous film, thereby providing higher withstand water pressure and moisture permeability.

As a method for providing the polyurethane resin containing a plant-derived component, for example, such a method may be employed that a divalent plant-derived polyol, such as castor oil diol, is dissolved in a polar solvent, such as dimethylformamide (DMF) and dimethylsulfoxide (DMSO), or a solvent, such as methyl ethyl ketone (MEK), toluene and xylene, to which a divalent isocyanate (such as hexamethylene diisocyanate, isophorone diisocyanate, diphenylmethane diisocyanate (MDI) and hydrogenated MDI) is added and sufficiently reacted to prepare a prepolymer having isocyanate groups or hydroxyl groups at the end thereof, and then a diol (such as a petroleum-derived material, e.g., ethylene glycol, propylene glycol and butylene glycol, and a plant-derived material, e.g., 1,3-propanediol and 1,2-hexanediol) or a divalent isocyanate (such as hexamethylene diisocyanate, isophorone diisocyanate, diphenylmethane diisocyanate (MDI) and hydrogenated MDI) is added thereto, thereby increasing the polymerization degree through chain extending reaction. However, the synthesis method of the polyurethane resin used in the invention is not limited to the aforementioned method.

Upon forming the prepolymer through reaction of the divalent plant-derived polyol and the divalent isocyanate, other polyol than the divalent plant-derived polyol, for example, a polyester polyol or a polyether polyol, may be copolymerized therewith. More specifically, a divalent petroleum-derived polyol, such as polyethylene adipate, polybutylene adipate, polycaprolactonediol, polyethylene glycol, polypropylene glycol and a polytetramethylene glycol, maybe copolymerized. In alternative, a polycarbonate polyol, a silicone polyol, a fluorine polyol, a polyamide polyol or the like maybe used for copolymerization. The polyols other than the plant-derived polyol may be mixed at a ratio of 50% by weight or less (solid content ratio) based on the total amount of the polyols, and the mixed amount is desirably 25% by weight or less (solid content ratio) for preventing the ratio of the plant-derived polyol from being decreased.

As the production method of the waterproof cloth of the invention, the method of laminating the waterproof layer of the polyurethane film containing a plant-derived component on a cloth includes a method of coating directly on the cloth (coating method) and a method of forming the waterproof layer solely and then laminating it on the cloth with an adhesive (joining method).

In the coating method, various kinds of coating methods, such as knife coating, knife-over-roll coating and reverse roll coating, may be employed.

As the joining method, for example, such a method may be employed that the waterproof layer formed on releasing paper by coating or the like operation is laminated on the cloth with an adhesive in a dot form or on the whole surface, and then the releasing paper is removed, but the invention is not limited to the method.

Examples of a preferred embodiment of a method for laminating the waterproof layer having moisture permeability include the following methods.

(1) A polyurethane resin solution containing a polyurethane resin containing a plant-derived component dissolved in a polar solvent that is soluble in water (represented by dimethylformamide (DMF) and dimethylsulfoxide (DMSO)) is coated on a cloth, and wet-gelled in water or an aqueous solution containing the polar solvent, thereby forming a finely porous film having both moisture permeability and waterproofness.

(2) A polyurethane resin containing a plant-derived component is copolymerized with a polyol containing polyethylene glycol to form a moisture permeable polyurethane resin, and a polyurethane resin solution containing the resin dissolved in a solvent capable of dissolving the resin is coated on a cloth, followed by drying the solvent, thereby forming a nonporous film having both moisture permeability and waterproofness.

### EXAMPLE

The invention will be described in more detail with reference to examples below, but the invention is not limited to the following examples. The measurement methods of capabilities in the present specification including the following examples were as follows.

### Measurement Methods

(1) Withstand water pressure: Measured according to JIS L1092.

(2) Moisture permeability: Measured according to the A-1 method and the B-1 method of JIS L1099.

(3) Hydrolyzability evaluation test (jungle test): Hydrolysis was accelerated in a high humidity thermostatic chamber at 70° C. and a relative humidity of 95%, and a maintenance ratio of withstand water pressure (i.e., a ratio of the withstand water pressure after the test with respect to the withstand water pressure before the test) was measured.

(4) Boiling test in 5% NaOH aqueous solution: A film was immersed in a solution in a boiling state (approximately 100° C.) in a stainless steel vat heated with an electromagnetic induction heater, and was observed for occurrence of dissolution, and the lapse of time was evaluated in terms of minute.

### Plant-Derived Polyurethane 25% Solution 1

25 g of castor oil diol 1 (PH-5002, produced by Itoh Oil Chemicals Co., Ltd., average hydroxyl group number: 2.03, hydroxyl group value: 43 mgKOH/g), 25 g of castor oil diol 2 (H-56, produced by Itoh Oil Chemicals Co., Ltd., average hydroxyl group number: 2.03, hydroxyl group value: 83 mgKOH/g), 50 g of polybutylene adipate (Nippollan (registered trademark) N-4060, produced by Nippon Polyurethane Industry Co., Ltd.) and 250 g of dimethylformamide (hereinafter abbreviated as DMF) were dissolved in a 1-L separable flask, to which 56.1 g of diphenylmethane diisocyanate (hereinafter abbreviated as MDI) was added under controlling the temperature to 45° C., followed by reacting at 45° C. for approximately 1 hour, thereby forming a prepolymer. Thereafter, the temperature was increased to 60° C., 10.7 g of ethylene glycol was added to perform chain extending reaction at 60° C., and polymerization was performed by adding 250 g of DMF in installments corresponding to increase in viscosity. The polymerization was completed after approximately 6 to 8 hours, and a polyurethane resin 25% solution having a plant-derived component ratio of 30.0% by weight (solid content ratio) was obtained.

### Plant-Derived Polyurethane 25% Solution 2

40 g of castor oil diol 1 (PH-5002, produced by Itoh Oil Chemicals Co., Ltd., average hydroxyl group number: 2.03, hydroxyl group value: 43 mgKOH/g), 40 g of castor oil diol 2 (H-56, produced by Itoh Oil Chemicals Co., Ltd., average hydroxyl group number: 2.03, hydroxyl group value: 83 mgKOH/g), 20 g of polybutylene adipate (Nippollan (registered trademark) N-4060, produced by Nippon Polyurethane Industry Co., Ltd.) and 250 g of DMF were dissolved in a 1-L separable flask, to which 57.6 g of MDI was added under controlling the temperature to 45° C., followed by reacting at 45° C. for approximately 1 hour, thereby forming a prepolymer. Thereafter, the temperature was increased to 60° C., 10.9 g of ethylene glycol was added to perform chain extending reaction at 60° C., and polymerization was performed by adding 256 g of DMF in installments corresponding to increase in viscosity. The polymerization was completed after approximately 6 to 8 hours, and a polyurethane resin 25% solution having a plant-derived component ratio of 47.5% by weight (solid content ratio) was obtained.

### Plant-Derived Polyurethane 25% Solution 3

50 g of castor oil diol 1 (PH-5002, produced by Itoh Oil Chemicals Co., Ltd., average hydroxyl group number: 2.03, hydroxyl group value: 43 mgKOH/g), 50 g of castor oil diol 2 (H-56, produced by Itoh Oil Chemicals co., Ltd., average hydroxyl group number: 2.03, hydroxyl group value: 83 mgKOH/g) and 250 g of DMF were dissolved in a 1-L separable flask, to which 58.6 g of MDI was added under controlling the temperature to 45° C., followed by reacting at 45° C. for approximately 1 hour, thereby forming a prepolymer. Thereafter, the temperature was increased to 60° C., 10.9 g of ethylene glycol was added to perform chain extending reaction at 60° C., and polymerization was performed by adding 259 g of DMF in installments corresponding to increase in viscosity. The polymerization was completed after approximately 6 to 8 hours, and a polyurethane resin 25% solution having a plant-derived component ratio of 58.9% by weight (solid content ratio) was obtained.

### Plant-Derived Polyurethane 25% Solution 4

70 g of castor oil diol 1 (PH-5002, produced by Itoh Oil Chemicals Co., Ltd., average hydroxyl group number: 2.03, hydroxyl group value: 43 mgKOH/g), 70 g of castor oil diol 2 (H-56, produced by Itoh Oil Chemicals Co., Ltd., average hydroxyl group number: 2.03, hydroxyl group value: 83 mgKOH/g) and 300 g of DMF were dissolved in a 1-L separable flask, to which 58.6 g of MDI was added under controlling the temperature to 45° C., followed by reacting at 45° C. for approximately 1 hour, thereby forming a prepolymer. Thereafter, the temperature was increased to 60° C., 9.0 g of ethylene glycol was added to perform chain extending reaction at 60° C., and polymerization was performed by adding 323 g of DMF in installments corresponding to increase in viscosity. The polymerization was completed after approximately 6 to 8 hours., and a polyurethane resin 25% solution having a plant-derived component ratio of 67.4% by weight (solid content ratio) was obtained.

### Plant-Derived Polyurethane 25% Solution 5

110 g of castor oil diol 1 (PH-5002, produced by Itoh Oil Chemicals Co., Ltd., average hydroxyl group number: 2.03, hydroxyl group value: 43 mgKOH/g) and 340 g of DMF were dissolved in a 1-L separable flask, to which 58.6 g of MDI was added under controlling the temperature to 45° C., followed by reacting at 45° C. for approximately 1 hour, thereby forming a prepolymer. Thereafter, the temperature was increased to 60° C., 5.0 g of ethylene glycol was added to perform chain extending reaction at 60° C., and polymerization was performed by adding 340 g of DMF in installments corresponding to increase in viscosity. The polymerization was completed after approximately 6 to 8 hours, and a polyurethane resin 25% solution having a plant-derived component ratio of 77.6% by weight (solid content ratio) was obtained.

### Petroleum-Derived Polyurethane 25% Solution

100 g of polybutylene adipate (Nippollan (registered trademark) N-4060, produced by Nippon Polyurethane Industry Co., Ltd.) and 250 g of DMF were dissolved in a 1-L separable flask, to which 53.6 g of MDI was added under controlling the temperature to 45° C., followed by reacting at 45° C. for approximately 1 hour, thereby forming a prepolymer. Thereafter, the temperature was increased to 60° C., 10.2 g of ethylene glycol was added to perform chain extending reaction at 60° C., and polymerization was performed by adding 241 g of DMF in installments corresponding to increase in viscosity. The polymerization was completed after approximately 6 to 8 hours, and a petroleum-derived polyurethane resin 25% solution was obtained.

### Example 1

Nylon ripstop taffeta constituted by a 50 denier nylon filament yarn was subjected to a water repelling treatment by immersing in a 30 g/L diluted solution of a fluorine water repellent agent (Unidyne (registered trademark) TG-571, produced by Daikin Industries, Ltd.), squeezing with a mangle to a squeezing ratio of 40%, drying at 120° C., and heat-treating at 130° C. for 30 seconds.

3.5 parts by weight of silica fine powder (Sylysia 350, produced by Fuji Silysia Chemical, Ltd.) was added to 150 parts by weight of the plant-derived polyurethane 25% solution 1, which were sufficiently immersed in 25 parts by weight of DMF and dispersed and agitated with a homomixer for approximately 15 minutes, to which 1 part by weight of fluorine water repellent agent (Daiaromer FF-121D, produced by Dainichiseika Color & Chemicals Mfg. Co., Ltd.), 2 parts by weight of a pigment (DILAC (registered trademark) WHITE L 7551, produced by Dainippon Ink & Chemicals, Inc.) and 1 part by weight of a crosslinking agent (Coronate (registered trademark) HL, produced by Nippon Polyurethane Industry Co., Ltd.) were added and agitated, thereby providing a polyurethane resin mixed solution having a plant-derived component ratio of 26.1% by weight (solid content ratio).

The solution was coated on the water repellent nylon ripstop taffeta with a knife-over-roll coater to a coated amount of 150 g/m², which was immersed in a bath having an aqueous solution containing 15% by weight of DMF as a gelling bath at 30° C. for 2 minutes to wet-coagulate the polyurethane resin mixed coating solution, and then rinsed with warmed water at 80° C. for 10 minutes and dried with hot air at 140° C., thereby providing a waterproof cloth having a plant-derived component ratio of 26.1% by weight (solid content ratio in the laminated resin layer). The resulting cloth was measured for withstand water pressure and moisture permeability.

The cloth was subjected to a jungle test and then measured for withstand water pressure, and the maintenance ratio thereof was obtained.

The boiling test in a 5% NaOH aqueous solution was performed in such a manner that the polyurethane resin mixed solution was coated on a polyester film with a knife-over-roll coater to a coated amount of 360 g/m², which was immersed in a bath having an aqueous solution containing 15% by weight of DMF as a gelling bath at 30° C. for 2 minutes to wet-coagulate the polyurethane resin mixed coating solution, and then rinsed with warmed water at 80° C. for 10 minutes and dried with hot air at 140° C., thereby providing a wet-processed porous film having a plant-derived component ratio of 26.1% (solid content ratio). The results are shown in Table 1.

### Example 2

Nylon ripstop taffeta constituted by a 50 denier nylon filament yarn was subjected to a water repelling treatment by immersing in a 30 g/L diluted solution of a fluorine water repellent agent (Unidyne (registered trademark) TG-571, produced by Daikin Industries, Ltd.), squeezing with a mangle to a squeezing ratio of 40%, drying at 120° C., and heat-treating at 130° C. for 30 seconds.

3.5 parts by weight of silica fine powder (Sylysia 350, produced by Fuji Silysia Chemical, Ltd.) was added to 150 parts by weight of the plant-derived polyurethane 25% solution 2, which were sufficiently immersed in 25 parts by weight of DMF and dispersed and agitated with a homomixer for approximately 15 minutes, to which 1 part by weight of fluorine water repellent agent (Daiaromer FF-121D, produced by Dainichiseika Color & Chemicals Mfg. Co., Ltd.), 2 parts by weight of a pigment (DILAC (registered trademark) WHITE L 7551, produced by Dainippon Ink & Chemicals, Inc.) and 1 part by weight of a crosslinking agent (Coronate (registered trademark) HL, produced by Nippon Polyurethane Industry Co., Ltd.) were added and agitated, thereby providing a polyurethane resin mixed solution having a plant-derived component ratio of 41.3% by weight (solid content ratio).

The solution was coated on the water repellent nylon ripstop taffeta with a knife-over-roll coater to a coated amount of 150 g/m², which was immersed in a bath having an aqueous solution containing 15% by weight of DMF as a gelling bath at 30° C. for 2 minutes to wet-coagulate the polyurethane resin mixed coating solution, and then rinsed with warmed water at 80° C. for 10 minutes and dried with hot air at 140° C., thereby providing a waterproof cloth having a plant-derived component ratio of 41.3% by weight (solid content ratio in the laminated resin layer). The resulting cloth was measured for withstand water pressure and moisture permeability.

The cloth was subjected to a jungle test and then measured for withstand water pressure, and the maintenance ratio thereof was obtained.

The boiling test in a 5% NaOH aqueous solution was performed in such a manner that the polyurethane resin mixed solution was coated on a polyester film with a knife-over-roll coater to a coated amount of 360 g/m², which was immersed in a bath having an aqueous solution containing 15% by weight of DMF as a gelling bath at 30° C. for 2 minutes to wet-coagulate the polyurethane resin mixed coating solution, and then rinsed with warmed water at 80° C. for 10 minutes and dried with hot air at 140° C., thereby providing a wet-processed porous film having a plant-derived component ratio of 41.3% by weight (solid content ratio). The results are shown in Table 1.

### Example 3

Nylon ripstop taffeta constituted by a 50 denier nylon filament yarn was subjected to a water repelling treatment by immersing in a 30 g/L diluted solution of a fluorine water repellent agent (Unidyne (registered trademark) TG-571, produced by Daikin Industries, Ltd.), squeezing with a mangle to a squeezing ratio of 40%, drying at 120° C., and heat-treating at 130° C. for 30 seconds.

3.5 parts by weight of silica fine powder (Sylysia 350, produced by Fuji Silysia Chemical, Ltd.) was added to 150 parts by weight of the plant-derived polyurethane 25% solution 3, which were sufficiently immersed in 25 parts by weight of DMF and dispersed and agitated with a homomixer for approximately 15 minutes, to which 1 part by weight of fluorine water repellent agent (Daiaromer FF-121D, produced by Dainichiseika Color & Chemicals Mfg. Co., Ltd.), 2 parts by weight of a pigment (DILAC (registered trademark) WHITE L 7551, produced by Dainippon Ink E. Chemicals, Inc.) and 1 part by weight of a crosslinking agent (Coronate (registered trademark) HL, produced by Nippon Polyurethane Industry Co., Ltd.) were added and agitated, thereby providing a polyurethane resin mixed solution having a plant-derived component ratio of 51.2% by weight (solid content ratio in the laminated resin layer).

The solution was coated on the water repellent nylon ripstop taffeta with a knife-over-roll coater to a coated amount of 150 g/m², which was immersed in a bath having an aqueous solution containing 15% by weight of DMF as a gelling bath at 30° C. for 2 minutes to wet-coagulate the polyurethane resin mixed coating solution, and then rinsed with warmed water at 80° C. for 10 minutes and dried with hot air at 140° C., thereby providing a waterproof cloth having a plant-derived component ratio of 51.2% (solid content ratio). The resulting cloth was measured for withstand water pressure and moisture permeability.

The cloth was subjected to a jungle test and then measured for withstand water pressure, and the maintenance ratio thereof was obtained.

The boiling test in a 5% NaOH aqueous solution was performed in such a manner that the polyurethane resin mixed solution was coated on a polyester film with a knife-over-roll coater to a coated amount of 360 g/m², which was immersed in a bath having an aqueous solution containing 15% by weight of DMF as a gelling bath at 30° C. for 2 minutes to wet-coagulate the polyurethane resin mixed coating solution, and then rinsed with warmed water at 80° C. for 10 minutes and dried with hot air at 140° C., thereby providing a wet-processed porous film having a plant-derived component ratio of 51.2% by weight (solid content ratio). The results are shown in Table 1.

### Example 4

A moisture permeable polyurethane resin solution containing 100 parts by weight of a moisture permeable polyurethane resin (HI-MUREN Y-237, produced by Dainichiseika Color & Chemicals Mfg. Co., Ltd.) mixed with 100 parts by weight of MEK was coated on the resin surface of the waterproof cloth having a plant-derived component ratio of 51.2% by weight (solid content ratio in the laminated resin layer) obtained in Example 3 by floating knife coating to a coated amount of 24 g/m², thereby providing a waterproof cloth having a top coating having a plant-derived component ratio of 45.4% by weight (solid content ratio in the laminated resin layer).

The cloth was subjected to a jungle test and then measured for withstand water pressure, and the maintenance ratio thereof was obtained.

The boiling test in a 5% NaOH aqueous solution was performed in such a manner that the polyurethane resin mixed solution was coated on a polyester film with a knife-over-roll coater to a coated amount of 360 g/m², which was immersed in a bath having an aqueous solution containing 15% by weight of DMF as a gelling bath at 30° C. for 2 minutes to wet-coagulate the polyurethane resin mixed coating solution, and then rinsed with warmed water at 80° C. for 10 minutes and dried with hot air at 140° C., thereby providing a wet-processed porous film having a plant-derived component ratio of 45.4% by weight (solid content ratio). The results are shown in Table 1.

### Example 5

Nylon ripstop taffeta constituted by a 50 denier nylon filament yarn was subjected to a water repelling treatment by immersing in a 30 g/L diluted solution of a fluorine water repellent agent (Unidyne (registered trademark) TG-571, produced by Daikin Industries, Ltd.), squeezing with a mangle to a squeezing ratio of 40%, drying at 120° C., and heat-treating at 130° C. for 30 seconds.

3.5 parts by weight of silica fine powder (Sylysia 350, produced by Fuji Silysia Chemical, Ltd.) was added to 150 parts by weight of the plant-derived polyurethane 25% solution 4, which were sufficiently immersed in 25 parts by weight of DMF and dispersed and agitated with a homomixer for approximately 15 minutes, to which 1 part by weight of fluorine water repellent agent (Daiaromer FF-121D, produced by Dainichiseika Color & Chemicals Mfg. Co., Ltd.), 2 parts by weight of a pigment (DILAC (registered trademark) WHITE L 7551, produced by Dainippon Ink E. Chemicals, Inc.) and 1 part by weight of a crosslinking agent (Coronate (registered trademark) HL, produced by Nippon Polyurethane Industry Co., Ltd.) were added and agitated, thereby providing a polyurethane resin mixed solution having a plant-derived component ratio of 58.7% by weight (solid content ratio).

The solution was coated on the water repellent nylon ripstop taffeta with a knife-over-roll coater to a coated amount of 150 g/m², which was immersed in a bath having an aqueous solution containing 15% by weight of DMF as a gelling bath at 30° C. for 2 minutes to wet-coagulate the polyurethane resin mixed coating solution, and then rinsed with warmed water at 80° C. for 10 minutes and dried with hot air at 140° C., thereby providing a waterproof cloth having a plant-derived component ratio of 58.7% by weight (solid content ratio in the laminated resin layer). The resulting cloth was measured for withstand water pressure and moisture permeability.

The cloth was subjected to a jungle test and then measured for withstand water pressure, and the maintenance ratio thereof was obtained.

The boiling test in a 5% NaOH aqueous solution was performed in such a manner that the polyurethane resin mixed solution was coated on a polyester film with a knife-over-roll coater to a coated amount of 360 g/m², which was immersed in a bath having an aqueous solution containing 15% by weight of DMF as a gelling bath at 30° C. for 2 minutes to wet-coagulate the polyurethane resin mixed coating solution, and then rinsed with warmed water at 80° C. for 10 minutes and dried with hot air at 140° C., thereby providing a wet-processed porous film having a plant-derived component ratio of 58.7% by weight (solid content ratio). The results are shown in Table 1.

### Comparative Example 1

Nylon ripstop taffeta constituted by a 50 denier nylon filament yarn was subjected to a water repelling treatment by immersing in a 30 g/L diluted solution of a fluorine water repellent agent (Unidyne TG-571, produced by Daikin Industries, Ltd.), squeezing with a mangle to a squeezing ratio of 40%, drying at 120° C., and heat-treating at 130° C. for 30 seconds.

3.5 parts by weight of silica fine powder (Sylysia 350, produced by Fuji Silysia Chemical, Ltd.) was added to 150 parts by weight of the petroleum-derived polyurethane 25% solution, which were sufficiently immersed in 25 parts by weight of DMF and dispersed and agitated with a homomixer for approximately 15 minutes, to which 1 part by weight of fluorine water repellent agent (Daiaromer FF-121D, produced by Dainichiseika Color & Chemicals Mfg. Co., Ltd.), 2 parts by weight of a pigment (DILAC (registered trademark) WHITE L 7551, produced by Dainippon Ink & Chemicals, Inc.) and 1 part by weight of a crosslinking agent (Coronate (registered trademark) HL, produced by Nippon Polyurethane Industry Co., Ltd.) were added and agitated, thereby providing a polyurethane resin mixed solution having a plant-derived component ratio of 0% by weight (solid content ratio).

The solution was coated on the water repellent nylon ripstop taffeta with a knife-over-roll coater to a coated amount of 150 g/m², which was immersed in a bath having an aqueous solution containing 15% by weight of DMF as a gelling bath at 30° C. for 2 minutes to wet-coagulate the polyurethane resin mixed coating solution, and then rinsed with warmed water at 80° C. for 10 minutes and dried with hot air at 140° C., thereby providing a waterproof cloth having a plant-derived component ratio of 0% by weight (solid content ratio in the laminated resin layer). The resulting cloth was measured for withstand water pressure and moisture permeability.

The cloth was subjected to a jungle test and then measured for withstand water pressure, and the maintenance ratio thereof was obtained.

The boiling test in a 5% NaOH aqueous solution was performed in such a manner that the polyurethane resin mixed solution was coated on a polyester film with a knife-over-roll coater to a coated amount of 360 g/m², which was immersed in a bath having an aqueous solution containing 15% by weight of DMF as a gelling bath at 30° C. for 2 minutes to wet-coagulate the polyurethane resin mixed coating solution, and then rinsed with warmed water at 80° C. for 10 minutes and dried with hot air at 140° C., thereby providing a wet-processed porous film having a plant-derived component ratio of 0% by weight (solid content ratio). The results are shown in Table 1.

### Comparative Example 2

Nylon ripstop taffeta constituted by a 50 denier nylon filament yarn was subjected to a water repelling treatment by immersing in a 30 g/L diluted solution of a fluorine water repellent agent (Unidyne TG-571, produced by Daikin Industries, Ltd.), squeezing with a mangle to a squeezing ratio of 40%, drying at 120° C., and heat-treating at 130° C. for 30 seconds.

3.5 parts by weight of silica fine powder (Sylysia 350, produced by Fuji Silysia Chemical, Ltd.) was added to 150 parts by weight of the plant-derived polyurethane 25% solution 5, which were sufficiently immersed in 25 parts by weight of DMF and dispersed and agitated with a homomixer for approximately 15 minutes, to which 1 part by weight of fluorine water repellent agent (Daiaromer FF-121D, produced by Dainichiseika Color & Chemicals Mfg. Co., Ltd.), 2 parts by weight of a pigment (DILAC (registered trademark) WHITE L 7551, produced by Dainippon Ink & Chemicals, Inc.) and 1 part by weight of a crosslinking agent (Coronate (registered trademark) HL, produced by Nippon Polyurethane Industry Co., Ltd.) were added and agitated, thereby providing a polyurethane resin mixed solution having a plant-derived component ratio of 67.5% by weight (solid content ratio in the laminated resin layer).

The solution was coated on the water repellent nylon ripstop taffeta with a knife-over-roll coater to a coated amount of 150 g/m², which was immersed in a bath having an aqueous solution containing 15% by weight of DMF as a gelling bath at 30° C. for 2 minutes to wet-coagulate the polyurethane resin mixed coating solution, and then rinsed with warmed water at 80° C. for 10 minutes and dried with hot air at 140° C., thereby providing a waterproof cloth having a plant-derived component ratio of 67.5% by weight (solid content ratio). The resulting cloth was measured for withstand water pressure and moisture permeability.

The cloth was subjected to a jungle test and then measured for withstand water pressure, and the maintenance ratio thereof was obtained.

The boiling test in a 5% NaOH aqueous solution was performed in such a manner that the plant-derived polyurethane resin mixed solution was coated on a polyester film with a knife-over-roll coater to a coated amount of 360 g/m², which was immersed in a bath having an aqueous solution containing 15% by weight of DMF as a gelling bath at 30° C. for 2 minutes to wet-coagulate the plant-derived polyurethane resin mixed coating solution, and then rinsed with warmed water at 80° C. for 10 minutes and dried with hot air at 140° C., thereby providing a wet-processed porous film having a plant-derived component ratio of 67.5% by weight (solid content ratio). The results are shown in Table 1.

TABLE 1

| | | | | | | | Comparative | Comparative |
|---|---|---|---|---|---|---|---|---|
| | | Example 1 | Example 2 | Example 3 | Example 4 | Example 5 | Example 1 | Example 2 |
| Plant-derived | % by | 26.1 | 41.3 | 51.2 | 45.4 | 58.7 | 0.0 | 67.5 |
| component ratio | weight | | | | | | | |
| Withstand water | kPa | 75 | 78 | 52 | 116 | 42 | 72 | 68 |
| pressure | | | | | | | | |
| Moisture | g/m² · hr | 472 | 435 | 402 | 256 | 172 | 464 | 65 |
| permeability A-1 | | | | | | | | |
| Moisture | g/m² · hr | 513 | 496 | 213 | 533 | 168 | 508 | 50 |
| permeability B-1 | | | | | | | | |
| Withstand water | 3 weeks | 72/96 | 73/94 | 50/96 | 109/94 | 41/98 | 52/72 | 56/82 |
| pressure after | 6 weeks | 68/91 | 70/90 | 45/87 | 101/87 | 39/93 | 28/39 | 52/76 |
| jungle test (after | 9 weeks | 67/89 | 69/88 | 44/85 | 98/84 | 38/90 | 5/7 | 55/81 |
| period shown | 12 weeks | 62/73 | 61/78 | 42/81 | 80/69 | 35/83 | — | 42/62 |
| right) (kPa)/ | 15 weeks | 58/77 | 54/69 | 38/73 | 84/72 | 33/79 | — | 46/68 |
| maintenance ratio | 18 weeks | 56/75 | 56/72 | 35/67 | 78/67 | 30/71 | — | 38/56 |
| (%) | | | | | | | | |
| Change starting | min | ≧120 | ≧120 | ≧120 | ≧120 | ≧120 | 25 | ≧120 |
| time in 5% NaOH aq | | | | | | | | |
| boiling test | | | | | | | | |

It is understood from the results shown in Table 1 that the waterproof cloths of Examples according to the invention all not only have excellent moisture permeability and waterproofness, but also have significantly excellent durability, which is exhibited by a maintenance ratio of withstand water pressure of 80% or more after lapsing 3 weeks in the hydrolyzability evaluation test under conditions of a temperature of 70° C. and a humidity of 95% RH and that of 60% or more after lapsing 18 weeks. On the other hand, the cloth of Comparative Example 1 using the petroleum-derived polyurethane resin and thus having a plant-derived component ratio of 0% by weight is inferior in durability and alkali resistance as compared to the cloths of Examples, and the cloth of Comparative Example 2 having a plant-derived component ratio exceeding 65% by weight has low moisture permeability and is slightly inferior in durability as compared to Examples.

The waterproof cloth of the invention solves the problem in durability of the conventional biodegradable plant-derived component resin, such as a polylactic acid resin, and exhibits excellent comfort, and thus it can be favorably used for sporting clothing, particularly outdoor sporting clothing, rainwear, and the like.

1. A waterproof cloth comprising a cloth having formed on one surface thereof by a coating method or a joining method a waterproof layer containing a polyurethane resin film containing from 10 to 65% by weight of a plant-derived component.

2. The waterproof cloth according to claim 1, wherein the polyurethane resin film containing from 10 to 65% by weight of a plant-derived component is a finely porous film or a non-porous film having moisture permeability.

3. The waterproof cloth according to claim 1, wherein the waterproof layer contains a finely porous film containing a polyurethane resin containing from 10 to 65% by weight of a plant-derived component and a non-porous film having moisture permeability containing a polyurethane resin containing from 10 to 65% by weight of a plant-derived component laminated on each other.

4. The waterproof cloth according to claims 1, wherein a polyol component constituting the polyurethane resin comprises a castor oil diol.

5. The waterproof cloth according to claim 4, wherein the castor oil diol is a castor oil series polyetherpolyester diol having an average hydroxyl group number of from 1.8 to 2.1 and a hydroxyl group value of from 41 to 85 mgKOH/g.

6. The waterproof cloth according to claims 1, wherein the waterproof cloth is able to withstand water pressure of 10 kPa or more.

7. The waterproof cloth according to claim 1, wherein the waterproof cloth has a moisture permeability of 104 g/m2.hr or more according to the A-1 method of JIS L1099.

8. The waterproof cloth according to claim 1, wherein the waterproof cloth retains at least 80% of its withstanding of water pressure of after a period of 3 weeks in a hydrolyzability evaluation test under conditions of a temperature of 70° C. and a humidity of 95% RH.
